(19) United States
(12) Patent Application Publication
(10) Pub. No.: US 2008/0023250 A1
(43) Pub. Date: Jan. 31, 2008

(54) Ergonomic machine control console

(76) Inventors: Robert E. Hefner, Creve Coeur, IL (US); Robert L. Stamate, Chillicothe, IL (US); Norval P. Thomson, Dunlap, IL (US); Timothy J. Silvers, Pekin, IL (US); Mark C. Redden, Washington, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/495,773

(22) Filed: Jul. 31, 2006

(51) Int. Cl. B62D 1/14; B60K 26/00

(52) U.S. Cl. 180/332; 180/333

(57) ABSTRACT

A steering control console for a mobile machine is disclosed. The control console has an armrest extending adjacent a seat in a forward direction generally parallel with a seat plane of symmetry. The control console also includes an operator interface device operatively connected to the armrest. The operator interface device is tiltable about a pivot axis through a range of approximately 70-90 degrees. The pivot axis is substantially aligned with the forward direction.

### TECHNICAL FIELD

The present disclosure is directed to a control console and, more particularly, to an ergonomic machine control console designed to relieve operator fatigue and improve control modulation.

### BACKGROUND

Machines such as, for example, wheel loaders, motor graders, agricultural tractors, and other types of heavy equipment are often large, complex, and difficult to operate. The majority of these machines have historically incorporated steering wheel systems for providing directional control over the machine, and separate transmission shift selectors for controlling the travel speed and/or direction of the machine.

Although these interface devices provided sufficient control over operation of the machines, they were problematic. In particular, the steering wheel systems required significant physical work and placed the operator in suboptimal upper torso postures. After a period of operating the steering wheel system, the operators became fatigued resulting in operator discomfort and a reduction in machine performance and efficiency. Further, because the operator's hand was required to travel from the steering wheel system to the transmission shift selector and back many times during a work period, additional fatigue and inefficiencies resulted.

One example of an operator interface designed to reduce operator fatigue while improving results of the machine is described in U.S. Pat. No. 5,042,314 (the '314 patent) issued to Rytter et al. on Aug. 27, 1991. The '314 patent describes a vehicle steering and transmission control mechanism located forward of an operator's seat and mounted to a left armrest. The mechanism includes a control handle that is transversely rockable about a generally horizontal axis, and a hydraulic steering actuator element connected at the bottom of the control handle. The mechanism also includes an electrical switch actuating element for movement by an operators thumb to change the speed of a multi-speed transmission.

While the vehicle steering mechanism of the '314 patent may have alleviated some of the problems associated with steering wheel type control systems and separate transmission shift selectors, the mechanism does not provide enough modulation or support to the machine operator. In particular, most control handles of the type described in the '314 patent and available on the market today for control of heavy equipment are rockable only through about 40 degrees of motion (e.g., about +/−20 degrees relative to a neutral axis). This range of motion, although suitable for low speed operating conditions at a worksite where high gain between steering input and machine steering movement is acceptable, may be difficult to use during high speed travel between worksites where the high gain can cause a small steering input to command excessive and abrupt machine steering movements. That is, the modulation available from the typical 40 degree range of motion is insufficient at high speeds, often requiring the operator to continually re-adjust the position of the control handle and compensate for the excessive machine steering movements.

In addition, because the pivot axis of typical control handles is either substantially aligned with the operator's arm when at rest or orthogonal to the operator's arm, movement of the control handle past the +/− 20 degree mark requires considerable side-to-side arm translation, resulting in operator fatigue. That is, as alignment of the pivot axis deviates from the operator's arm, the operator's movement likewise deviates from low-fatigue wrist twisting toward strenuous side-to-side arm movements.

The disclosed control console is directed towards overcoming one or more of the problems as set forth above.

### SUMMARY OF THE INVENTION

In one aspect, the present disclosure is directed to a control console. The control console includes an armrest extending adjacent a seat in a forward direction generally parallel with a seat plane of symmetry. The control console also includes an operator interface device operatively connected to the armrest. The operator interface device is tiltable about a pivot axis through a range of approximately 70-90 degrees. The pivot axis is substantially aligned with the forward direction.

In another aspect, the present disclosure is directed to a method of steering a mobile machine. The method includes receiving a tilt angle input greater than about 35 degrees relative to a neutral reference and determining a steering angle output corresponding to the tilt angle input. The method further includes maneuvering the mobile machine to affect the steering angle output.

In yet another aspect, the present disclosure is directed to a control console. The control console includes an armrest extending adjacent a seat in a forward direction generally parallel with a seat plane of symmetry. The control console also includes an operator interface device operatively connected to the armrest. The operator interface device is tiltable about a pivot axis that is inclined at an oblique angle relative to the upper armrest surface.

### BRIEF DESCRIPTION OF THE DRAWINGS

FIG. 1 is a diagrammatic illustration of an exemplary disclosed machine;

FIG. 2 is a pictorial illustration of an exemplary disclosed operator station for use with the machine of FIG. 1;

FIG. 3 is a side-view diagrammatic illustration of an exemplary disclosed control console for use with the operator station of FIG. 2; and

FIG. 4 is an oblique-view diagrammatic illustration of another exemplary disclosed control console for use with the operator station of FIG. 2.

### DETAILED DESCRIPTION

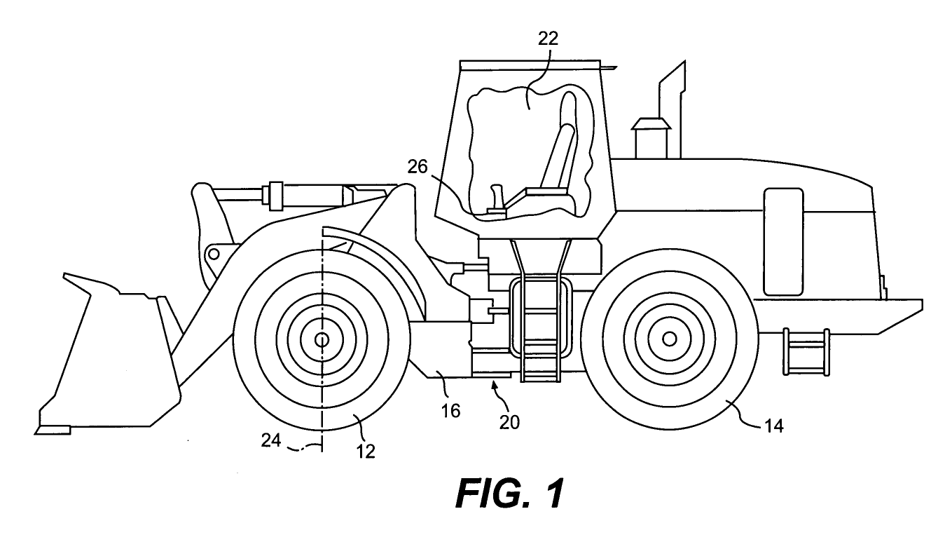

An exemplary embodiment of a machine 10 is illustrated in FIG. 1. Machine 10 may be a mobile machine that performs some type of operation associated with an industry such as mining, construction, farming, transportation, or any other industry. For example, machine 10 may be an earth moving machine such as a wheel loader, an excavator, or a motor grader. Machine 10 may include a forward traction device 12, a rear traction device 14, and a frame 16 connecting forward traction device 12 to rear traction device 14. Machine 10 may also include an operator station 22 for manual control of machine 10.

Both forward and rear traction devices 12, 14 may include one or more wheels located on each side of machine 10 (only one side shown). Alternatively, forward and/or rear traction devices 12, 14 may include tracks, belts, or other traction devices known in the art. Any of forward and rear traction devices 12, 14 may be driven and/or steerable. Frame 16 may connect forward traction device 12 to rear traction device 14 by way of, for example, an articulated joint 20. It is contemplated that machine 10 may be steered by causing forward traction devices 12 to rotate about a vertical axis 24, by driving the forward and/or rear traction devices 12 located on opposing sides of machine 10 at differing speeds and/or in different directions, and/or by causing a front portion of machine 10 to be rotated about articulated joint 20 relative to a rear portion. These steering actions may be affected hydraulically, electrically, pneumatically, mechanically, or in any other manner in response to a steering input.

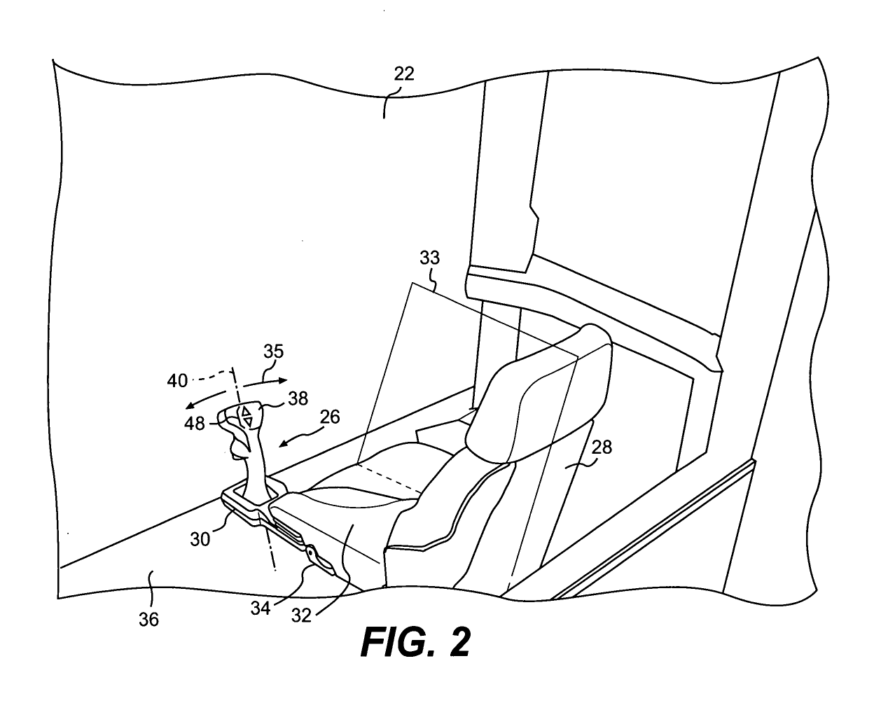

Operator station 22 may house a control console 26. In particular, as illustrated in FIG. 2, operator station 22 may include a seat 28, with control console 26 being attached to seat 28. Control console 26 may include a base member 30 operatively connected to an armrest 32 of seat 28 such that control console 26 may move with seat 28 during adjustment of seat 28 by an operator. One or more fastening devices 34 may provide adjustability of console 26 relative to armrest 32. It is contemplated that control console 26 may alternatively be connected to a floor 36 of operator station 22, to a wall (not shown) of operator station 22, or in any other manner known in the art. Control console 26 may further include one or more operator interface devices 38 located forward of armrest 32 for steering control of machine 10.

Base member 30 may embody a generally rectangular housing configured to support operator interface device 38 on an upper portion thereof. Base member 30 may enclose and protect the internal mechanisms of operator interface device 38, as well as the electrical and/or hydraulic connections between operator interface device 38 and external motors or electronic control modules (not shown) located elsewhere on machine 10. As indicated above, base member 30 may mount to armrest 32 via fastening devices 34.

In one embodiment, operator interface device 38 may be a single axis lever (SAL). It is contemplated, however, that, instead of a SAL, operator interface device 38 may alternatively include a multi-axis lever, a full or partial steering wheel, or other operator interface devices that require at least a generally transverse movement input from the operator for steering actuation. For the purposes of this disclosure, the transverse direction and a forward direction may be related and defined with respect to seat 28 and/or the location and movement of an operator's forearm. For example, seat 28 may include a substantially vertical plane of symmetry 33, about which seat 28 is generally horizontally symmetric. The forward direction, in this example, may be substantially parallel with plane 33 and substantially parallel with un upper surface of armrest 32 upon which an operator's fore arm rests during operation of machine 10. With respect to the operator's forearm, when the operator is properly situated within seat 28, the forearm is kept in contact with armrest 32 along the length of armrest 32, and the upper arm is rotated about the shoulder joint in a plane substantially parallel to plane 33, the forearm movement may be in the forward direction. Correspondingly, the transverse direction may be substantially orthogonal to plane 33 and parallel with the upper surface of armrest 32, as indicated by arrows 35.

Operator interface device 38 may control a steering motion of machine 10. In particular, a left side-tilting movement of operator interface device 38 away from a neutral axis 40 (viewed from an operator's perspective) about pivot axis 42 may cause machine 10 to steer to the left. A right side-tilting movement of operator interface device 38 away from neutral axis 40 about pivot axis 42 (viewed from the operator's perspective) may cause machine 10 to steer to the right. Operator interface device 38 may be spring biased to return to neutral axis 40 when released by the operator or, alternatively, may include a braking mechanism (not shown) to hold operator interface device 38 in an actuated position when released. It is contemplated that an actuation position or speed of operator interface device 38 may correspond with an angular position of forward traction devices 12, a steering speed of forward traction devices 12, an angular position of articulation joint 20, or an orienting speed of articulation joint 20.

Operator interface device 38 may have a predefined range of motion. That is, operator interface device 38 may be movable away from neutral axis 40 in a first transverse direction (i.e., to the left when viewed from the operator's perspective) a first predetermined angle, and away from neutral axis 40 in a second transverse direction (i.e., to the right when viewed from the operator's perspective) a second predetermined angle. In one embodiment, the first and second predetermined angles may be substantially equal, with the total range of motion being about 70-90 degrees. For optimal operator comfort, however, operator interface device 38 may be limited to a maximum tilt angle of 40 degrees to the left and 40 degrees to the right (e.g., +/− 40 degrees). This range of motion may allow sufficient steering modulation, even at high speeds, without undue operator fatigue.

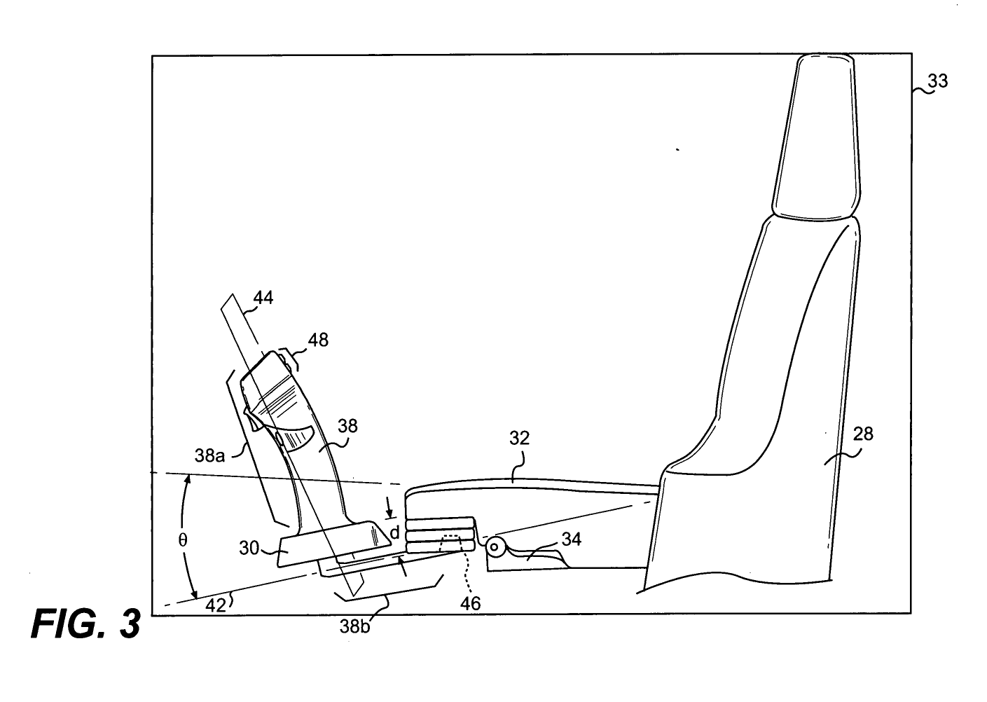

Operator interface device 38 may be oriented away from the operator in the forward direction to facilitate the +/− 40 degree range of motion and operator comfort. That is, in order to minimize side-to-side movement of an operator's arm during the tilting of operator interface device 38 through the 40 degrees, a pivot axis 42 of operator interface device 38 may be angled downward away from the upper surface of armrest 32 by an angle θ, as illustrated in FIG. 3. In one embodiment, angle θ may be in the range of 10-15 degrees. However, for optimal operator comfort, angle θ may be selected such that pivot axis 42 extends through the intersection of the upper armrest surface and a back support portion of seat 28 (e.g., through the elbow joint of an operator when the operator is properly situated within operator station 22). In the embodiment of FIG. 3, this optimal angle may be about 12 degrees, with pivot axis 42 being substantially aligned with plane 33. By orienting the pivot axis 42 of operator interface device 38 though the elbow joint of the operator, the operator's steering input movement may be primarily low fatigue twisting of the wrist rather than side-to-side motion of the operator's arm, even when steering at the extreme angles of 40 degrees from neutral. It is contemplated that angle θ may be similarly measured from a floor plane of operator station 22, a ground level axis, or other suitable reference point, if desired.

It is contemplated that operator interface device 38 may alternatively include a multi-axis controller. If multi-axis controllers are implemented within control console 26, operator interface device 38 may also be movable in the forward direction to initiate a first function of machine 10 (i.e., forward/reverse travel and/or acceleration of machine 10), in the transverse direction to control steering, and, possibly, in a direction between the forward and transverse directions such that both the first function and steering are initiated. In this arrangement, at least one of the forward and transverse pivot axis of the multi-axis controller may be angled downward away from the upper surface of armrest 32 in the forward direction by angle θ.

Operator interface device 38 may be cantilevered such that a transverse plane of motion 44 (e.g., the plane formed by the arc-like movement of operator interface device in the transverse direction) is axially offset from the device's rotation joint 46. Specifically, operator interface device 38 may include a handle portion 38a, and a support member 38b fixedly connected to handle portion 38a. Support member 38 may be received at one end by rotation joint 46, which is located at a position axially spaced apart from the transverse plane 44. In this embodiment, support member 38b may extend along both an axial direction of handle portion 38a and along pivot axis 42 to rotation joint 46, thereby forming an L-shape. This configuration may help to minimize the spatial footprint of operator interface device 38 within station 22.

The distance from handle portion 38a to pivot axis 42 may be limited for operator comfort. That is, in order to minimize side-to-side movement of the operator's arm, the distance from handle portion 38a to pivot axis 42 may be limited to less than a predetermined distance “d”. As the distance “d” decreases, the arc length through which the operator's arm must move to accomplish the same steering input angle may likewise decrease. In one embodiment “d” may be limited to less than about 15 mm.

Operator interface device 38 may control a second machine function. Specifically, operator interface device 38 may include one or more transmission input controls 48 located on handle portion 38a. These input controls may affect a transmission operation such as, for example, transmission shifting between output gear ratios, selection of a maximum desirable output gear ratio, transmission directional changes, and other transmission operations known in the art.

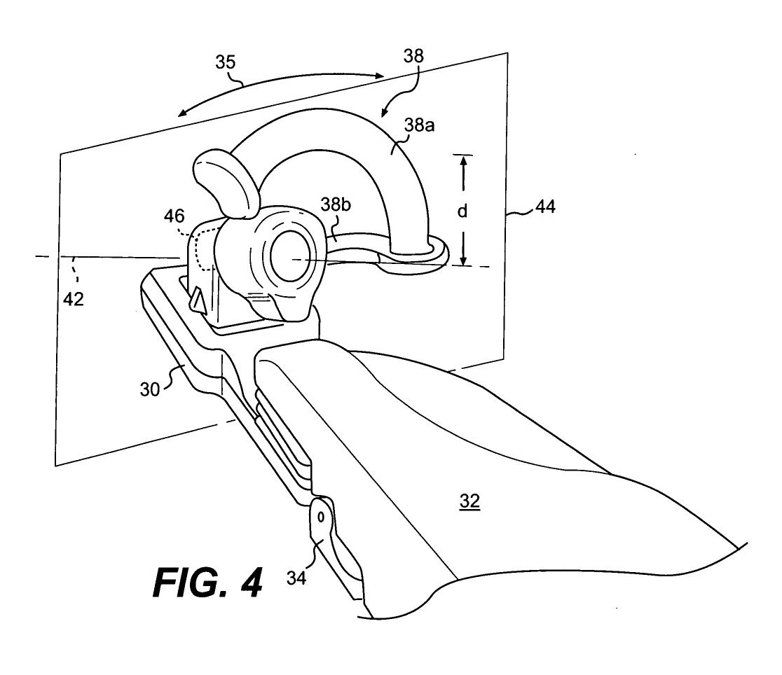

FIG. 4 illustrates an alternative embodiment of operator interface device 38. In this embodiment, handle portion 38a may be curved to form a partial steering wheel mechanism tiltable about pivot axis 42. In this embodiment, the distance “d” may be substantially equal to the general radius of the partial steering wheel mechanism. It is contemplated that, although a partial steering wheel is illustrated in FIG. 4 and utilized to minimize the spatial foot print of operator interface device 38, a full steering wheel mechanism may alternatively be utilized, if desired. In either situation the range of motion of interface device 38 may still be about 70-90 degrees in the transverse direction, and pivot axis 42 may still be oriented to pass through an operator's elbow when properly situated on armrest 32. Although the transverse plane of motion 44 of operator interface device 38 is illustrated in FIG. 4 as still being offset from rotation joint 46, rotation joint 46 is located forward of plane 44 in this embodiment.

### INDUSTRIAL APPLICABILITY

The disclosed control console may be applicable to any machine requiring operator input to steer the machine. The disclosed control console may effectively reduce operator fatigue by providing an ergonomically located operator interface device have extensive modulation capacity. The operation of control console 26 will now be explained.

During operation of machine 10, an operator may control multiple machine functions with the same hand, with little hand or arm movement. Specifically, while the operator's arm is positioned on armrest 32, both steering and transmission control may be accomplished. For example, a steering input may be generated by transversely rocking operator interface device 38 to the right through an angle up to about 40 degrees and to the left through an angle up to about 40 degrees. In addition, transmission controls 48 may be manipulated to indicate a desired change in transmission operation. Once the steering input and/or transmission input has been received, the control module may determine a steering angle output and/or a transmission output command signal to affect the desired steering angle or transmission operation.

To relieve operator fatigue, operator interface device 38 may be located in an ergonomic manner. For example, pivot axis 42 may be angled relative to the upper surface of armrest 32 by about 12 degrees such that the axis about which operator interface device tilts runs approximately through the elbow joint of an operator. This orientation combined with the distance limitation of handle portion 38a to pivot axis 42 may minimize the movement required of an operator to affect the desired steering.

The location and design of handle portion 38a relative to pivot joint 46 may reduce the spatial footprint of control console 26. In particular, because the pivot joint and associated electronics are axially spaced apart from handle portion 38a, these components may be located within armrest 32 or another location out of the way of operator movements.

Other embodiments will be apparent to those skilled in the art from consideration of the specification and practice of the disclosed embodiments. It is intended that the specification and examples be considered as exemplary only, with a true scope of the disclosure being indicated by the following claims.

What is claimed is:

1. A control console, comprising:
an armrest extending adjacent a seat in a forward direction generally parallel with a seat plane of symmetry; and
an operator interface device operatively connected to the armrest and being tiltable about a pivot axis through a range of approximately 70-90 degrees, wherein the pivot axis is substantially aligned with the forward direction.

2. The control console of claim 1, wherein the operator interface device is tiltable about the pivot axis from a neutral position in one direction through approximately 40 degrees and from the neutral position in an opposing direction through approximately 40 degrees.

3. The control console of claim 1, wherein:
the arm rest has an upper armrest surface intended to support an operator's forearm; and
the pivot axis is inclined at an oblique angle relative to the upper armrest surface.

4. The control console of claim 3, wherein the oblique angle is in the range of approximately 10-15 degrees.

5. The control console of claim 4, wherein the oblique angle is approximately 12 degrees.

6. The control console of claim 1, wherein:
the armrest has an upper armrest surface intended to support an operator's forearm; and
the pivot axis is inclined relative to the upper armrest surface to pass through an intersection of the upper armrest surface and a back support portion of the seat.

7. The control console of claim 1, wherein the operator interface device includes a transmission control input mechanism.

8. The control console of claim 1, wherein:
the operator interface device includes a handle portion having a pivot joint at the pivot axis; and
the distance from the pivot joint to the handle portion is less than about 15 mm.

9. The control console of claim 8, wherein the handle portion has an axial direction and includes a support structure fixedly connected to the handle portion and extending in both the axial direction and in the direction of the pivot axis to form an L-shape.

10. The control console of claim 1, wherein the operator interface device includes a partial steering wheel cantilevered from the pivot axis.

11. The control console of claim 1, wherein:
the operator interface device has a handle portion tiltable within a tilt plane, and a pivot joint at the pivot axis; and
the tilt plane is axially spaced apart from the pivot joint along the pivot axis.

12. A mobile machine, comprising:
a steering mechanism configured to affect steering of the mobile machine;
an operator station associated with operator control of the steering mechanism; and
the a control console as in claim 1 located within the operator station and being configured to control operation of the steering mechanism.

13. A method of steering a mobile machine, the method comprising:
receiving a tilt angle input greater than about 35 degrees relative to a neutral reference;
determining a steering angle output corresponding to the tilt angle input; and
maneuvering the mobile machine to affect the steering angle output.

14. The method of claim 13, wherein the tilt angle input is limited to less than about 40 degrees.

15. A control console, comprising:
an armrest extending adjacent a seat in a forward direction generally parallel with a seat plane of symmetry; and
an operator interface device operatively connected to the armrest and being tiltable about a pivot axis, the pivot axis being inclined at an oblique angle relative to the upper armrest surface.

16. The control console of claim 15, wherein the pivot axis is substantially aligned with the seat plane of symmetry.

17. The control console of claim 15, wherein the oblique angle is approximately 12 degrees.

18. The control console of claim 15, wherein:
the armrest has an upper armrest surface intended to support an operator's forearm; and
the pivot axis is inclined relative to the upper armrest surface to pass through an intersection of the upper armrest surface and a back support portion of the seat.

19. The control console of claim 1, wherein:
the operator interface device includes a handle portion having a pivot joint at the pivot axis; and
the distance from the pivot joint to the handle portion is less than about 15 mm.

20. A mobile machine, comprising:
a steering mechanism configured to affect steering of the mobile machine;
an operator station associated with operator control of the steering mechanism; and
the a control console as in claim 15 located within the operator station and being configured to control operation of the steering mechanism.
